(19) United States
(12) Patent Application Publication
(10) Pub. No.: US 2017/0129539 A1
(43) Pub. Date: May 11, 2017

(54) TRANSPORT VEHICLE HAVING A VARIABLE WIDTH

(71) Applicant: Scheuerle Fahrzeugfabrik GmbH, Pfedelbach (DE)

(72) Inventors: Axel Krämer, Pfedelbach (DE); Kurt Bannert, Pfedelbach (DE); Stefan Rüger, Pfedelbach (DE)

(21) Appl. No.: 15/381,557

(22) Filed: Dec. 16, 2016

Related U.S. Application Data
(63) Continuation of application No. PCT/EP2015/001223, filed on Jun. 17, 2015.

(30) Foreign Application Priority Data
Jun. 24, 2014 (DE) 10 2014 009 036.1
Jun. 24, 2014 (DE) 20 2014 005 055.4

(51) Int. Cl. B62D 21/14; B62D 59/04; B62D 63/08; B62D 13/00; B62D 33/08; B62D 63/02; B62D 63/06

(52) U.S. Cl. CPC B62D 21/14; B62D 63/025; B62D 59/04; B62D 63/061; B62D 63/068; B62D 13/005; B62D 33/08; B62D 63/08

(57) ABSTRACT

A transport vehicle includes a chassis with at least two load carriers which are placed next to and at a distance from each other. The distance between the at least two load carriers are modifiable in order to modify the width of the transport vehicle. The at least two load carriers of the transport vehicle are connected to one another by at least one articulated twin-arm structure.

### CROSS-REFERENCE TO RELATED APPLICATIONS

This continuation application claims priority to PCT/EP2015/001223 filed on Jun. 17, 2015 which has published as WO 2015/197173 A1 and also the German application number 10 2014 009 036.1 filed on Jun. 24, 2014 and application number 20 2014 005 055.4 filed on Jun. 24, 2014, the entire contents of which are fully incorporated herein with these references.

### DESCRIPTION

### Field of the Invention

The invention relates to a transport vehicle, in particular a self-propelled transport vehicle, having a chassis with at least two load carriers being arranged side-by-side and spaced from each other, whose mutual distance is, for changing the width of the transport vehicle, changeable.

### Background of the Invention

For transporting loads having an excess width or for the return journey of the transport vehicle without load respectively, it is of advantage that the width of the vehicle used for transporting a heavy load can be changed. In addition, in some states of the USA special legal provisions for vehicles for transporting heavy loads are in force, by which the allowable load per axle is, depending on the track width of the vehicle, limited, so that a variable width and hence a track width is of advantage in order to comply with the legal regulations and to exploit the maximum axle load. For this purpose it is provided in the known transport vehicle that between the two parallel load carriers a central carrier is arranged and that the two load carriers are connected with the central girder by means of cross beams being variable in their length. By way of a corresponding displacement of the load girders it is therefore possible to change the width of the known transport vehicle and hence its track width.

From WO 2010/048674 A1 a transport vehicle is known, which comprises two juxtaposed load girders spaced apart from each other, whose mutual distance can be varied for changing the width of the transport vehicle. Between the two load girders an X-shaped connecting element is arranged, which comprises two beams being connected by a joint arranged in the middle. The first beam runs from a front portion of the first load girder to the end portion of the second load girder, the second beam runs from a front portion of the second load girder to a rear portion of the first load girder, so that the two beams cross in their middle and are connected via a hinge. Each of the two beams is connected with the rear portion of the respective load girder and is received pivotally and slidingly in guide elements, so that they are movable along the load girder. If the two load girders are moved apart, the front ends of the two beams move along the guide elements towards the rear end of the load girders, so that the X defined by the two crossing beams broadens. For reducing the width of the vehicle the front portions of the beams are slided forwardly, so that the X defined by the crossing beams narrows.

From WO 96/39320 A1 a wheel chair is known, in which the aforementioned designed principle is realized too. This wheel chair has got two longitudinal frames, between which two beams are arranged in an X-configuration. Each front end of the crossing beams is arranged in the respective longitudinal frame slidingly and the rear part of the two beams is connected firmly with the respective longitudinal frame.

From U.S. Pat. No. 4,221,398 a transport vehicle of the type mentioned afore is known, having the form of a drawbar trailer and a low loader with several steering axles, whose width and track width can be increased and decreased when required, by moving two chassis parts, each having a row of wheel bogies, transverse to the direction of travel or to a vertical longitudinal central axis respectively, apart or together. The wheel bogies of each steering axle are steered there independently by separate steering cylinders, which are arranged in each of the two chassis parts.

Furthermore, from U.S. Pat. No. 4,772,038, U.S. Pat. No. 5,118,245 or U.S. Pat. No. 5,326,128 transport vehicles with a variable width and track width are known. U.S. Pat. No. 3,339,942 discloses a low loader with variable track width, whose width can be reduced when driving unloaded.

DE 2 219 447 A discloses a transport vehicle in the form of a low loader consisting of two traverses or load carriers, each carrying a row of successively arranged steerable wheel bogies, and two traction units. To steer the wheel bogies of both traverses simultaneously, in total four lockable and telescopable (i.e. capable of telescoping) track rods are provided, which are arranged in pairs between each of the traction units and the wheel bogies of the adjacent steering or pendulum axis. However, this means that at any adjustment of the width and the track width of the low loader the length of all four telescopable track rods must be adjusted and locked after this adjustment, which causes significant setup times. In addition, the telescopable track rods are arranged in respect to the longitudinal vehicle axis at an angle of other than 90 degrees, which also changes when adjusting the width and the track width of the low loader, so that the amount of the length adjustment of the track rods necessary does not correspond to the amount of the adjustment of the track width, but must be calculated for the different track width depending on the angular position of the track rods. In addition, the turning movement of a tractor unit results in different angular orientations of the track rods being arranged on both sides of the traction unit, so that for transmitting the pivotal movement of the traction unit to the two wheel bogies of the adjacent steering or pendulum axle it seems doubtful whether or not the steering angle of these two wheel bogies is identical, despite of a relatively complicated kinematics.

It is the object of the present invention to further develop a transport vehicle, in particular a self-propelled transport vehicle, of the kind mentioned at the beginning in such a way that a width and consequently a track width adjustment is possible in a simple way.

### SUMMARY OF THE INVENTION

This object is achieved by the present invention that at least two load carriers of the transport vehicle are connected by a scissor link, that at least one scissor link comprises two arms, whose first end portions are hingedly connected with one load carrier and whose second end portions are connected via a joint, that at least one scissor link comprises two arms, so that the first end portion of the first arm is pivotally connected with the first end portion of the first arm and the first end portion of the second arm of said scissor link is pivotally connected with the second load carrier, so that the second end portion of the first arm and the second end portion of the second arm are connected via a joint.

It is understood by those skilled in the art that the use of the term “load carrier” can be used interchangeably with the term “load girder” as they mean and teach the same concept of a girder/carrier that can accommodate a load.

By the inventive measures in an advantageous way a transport vehicle is created, which is variable in its width and hence in its track width, which is characterized in that this width adjustment can be performed with simple means, namely with scissor links. In an advantageous way the two load carriers of the transport vehicles being connected by the scissor links are only connected by the scissor links and, preferably, by a cross beam being variable in its length. The design of the wheel arrangements carrying the load carrier is therefore not affected by the width and track width adjustability achieved by the inventive measures.

An advantageous further development of the invention provides that at least one, preferably all or almost all wheel assemblies of the transport vehicle are designed steerable. Such a measure has got the advantage that the width adjustment of the inventive transport vehicle can be achieved by a respective positioning of the wheels of the wheel assemblies in conjunction with a subsequent driving movement of the transport vehicle.

A further advantageous further development of the invention provides that the transport vehicle has at least one means for changing the angular position of the arms of the corresponding scissor link, which engages on at least one scissor link. Preferably it is provided that this means, in particular a double-acting cylinder, is arranged between two cooperating scissor links, so that by acting on the scissor links an adjustment of the distance of their pivot points in the direction of the load carriers can be achieved. The change of the angular position of the arms of the scissor links caused in that way results in an advantageous manner in a change of the width of the transport vehicle.

Further advantageous developments of the invention are the subject matter of the depending claims.

### BRIEF DESCRIPTION OF THE DRAWINGS

Further details and advantages of the invention are disclosed in the exemplary embodiments, which are described in the following with reference to the two exemplary embodiments. It shows:

FIG. 1 is a perspective view of a first exemplary embodiment of a transport vehicle;

FIG. 2 is a side view of the exemplary embodiment;

FIG. 3 is a top view of the first exemplary embodiment at an enlarged width;

FIG. 4 is a top view on the first exemplary embodiment at a reduced width;

FIG. 5 is a top view on a second exemplary embodiment at an enlarged width; and

FIG. 6 is a top view on the second exemplary embodiment at a reduced width.

### DETAILED DESCRIPTION OF THE PREFERRED EMBODIMENTS

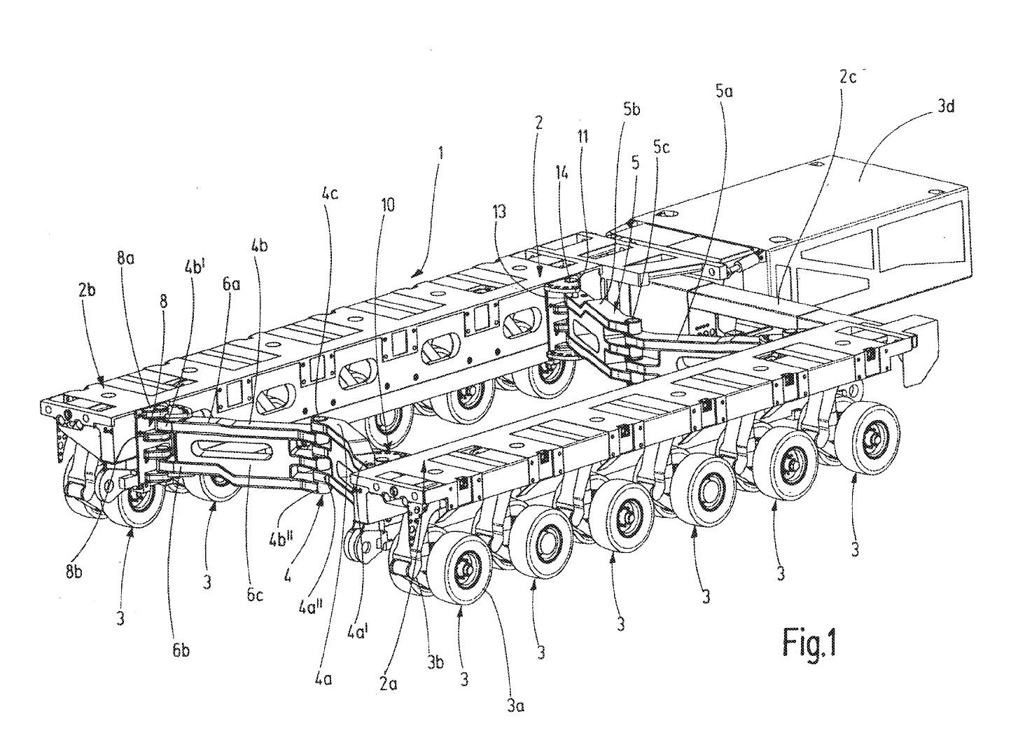

In FIGS. 1 to 4 a first exemplary embodiment of a transport vehicle, generally designated with 1, is shown, which is, in the case described here, designed as a self-propelled transport vehicle. Such self-propelled transport vehicles are known under the designation SPMT-vehicles (self-propelled modular trailer) and therefore need not be described in detail.

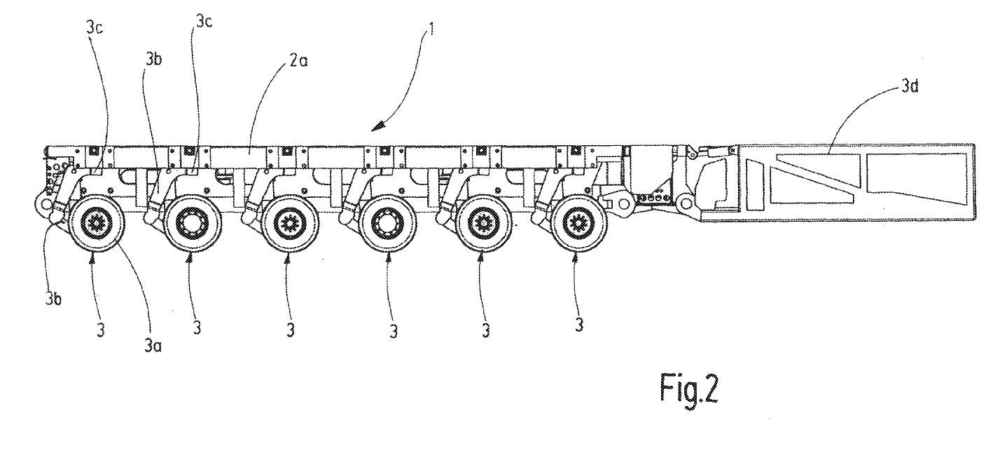

The transport vehicle 1 comprises a chassis 2, which has two load carriers (i.e. load girders) 2a, 2b, which are arranged spaced apart and can be moved relative to each other in a transverse direction. Preferably, they are constructed identically, so that in the following only the load carrier 2a, which is the right one in FIG. 1, is described in detail. Under the load carrier 2a a number of wheel assemblies 3 is provided, each having a dual wheel 3a, which is connected by a pendulum axle 3b with a turntable 3c (see FIG. 2) of the wheel assembly 3. The drive energy required for driving and steering the wheel assemblies 3 is generated by a drive unit 3d, at it is known e.g. under the designation PPU (Power Pack Unit) and therefore is not described in detail.

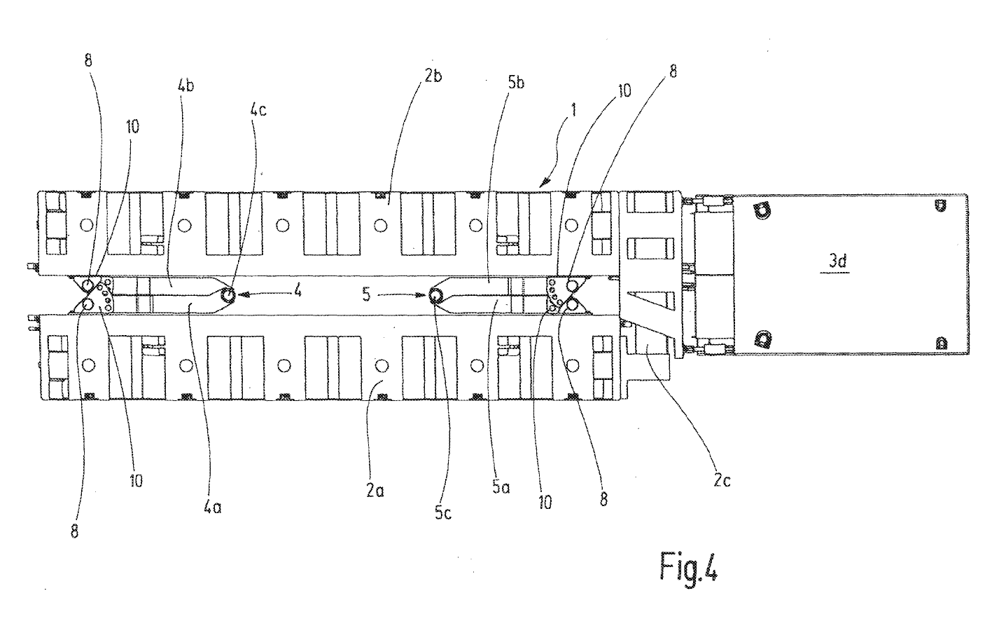

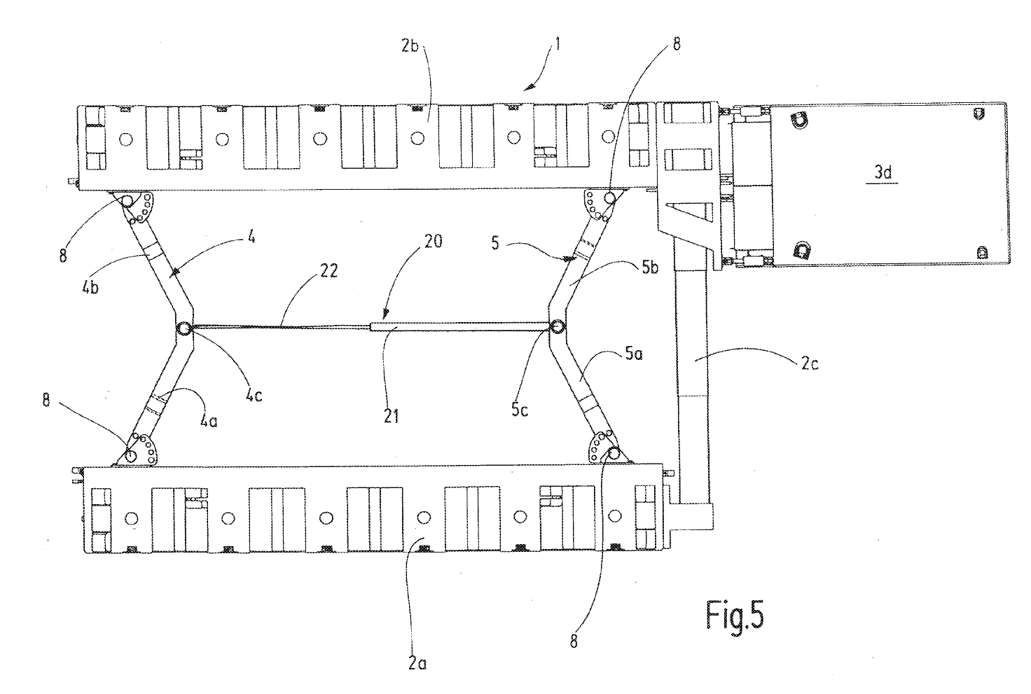

It is essential that the two load carrier 2a and 2b of the chassis 2 are connected by two scissor links 4 and 5 with each other, each having two arms 4a and 4b and 5a and 5b respectively. A first end portion 4a′ and 4b′ respectively of the arms 4a and 4b of the first scissor link 4 is—as best seen from FIGS. 4 and 5—hinged movably to each of the two load carriers 2a and 2b of the chassis 2 and the two second end portions 4a″, 4b″ of the arms 4a, 4b are connected via a joint 4c. In a corresponding way the first end portions 5a′ and 5b′ of the two arms 5a and 5b of the second scissor link 5 are pivotally connected with the load carriers 2a and 2b and their second end portion 5a″, 5b″ are connected via a joint 5c. Each of the arms 4a, 4b and 5a, 5b of the two scissor links 4 and 5 comprises two carriers 6a and 6b being arranged one above the other, which are connected via a joint element 6c in such a way that the two carriers 6a, 6b produce at both ends the joint element 6c, so that protruding end portions 6a′ and 6b′ respectively are provided, which delimit a free space. The end portion 6a′ and 6b′ of the two carriers 6a and 6b of each arm 4a, 4b and 5a, 5b of the scissor links 4 and 5 therefore can be inserted between articulating elements 8a and 8b of a joint 8, which is firmly connected with the load carriers 2a and 2b. The articulation elements 8a and 8b as well as the end portions 4a′, 4b′ and 5a′, 5b′ of the arms 4a, 4b and 5a, 5b of the scissor links 4 and 5 each comprise an opening 8c, through which a bolt 8d of the joint 8 can be moved through, so that the arms 4a, 4b and 5a, 5b of the scissor links 4 and 5 are pivotally connected with the load carriers 2a, 2b.

The load carriers 2a and 2b are connected firmly via a cross beam 2c, whose length can be varied, so that the stability of the vehicle 1 is enhanced.

The joints 8 comprise a means 10 for defining the angular position of the arms 4a-5b of the scissor links 4 and 5 in respect to the load carriers 2a and 2b. This one has got a perforated plate 11, which has got openings 12 forming a hole pattern, which are arranged concentrically to the pivot axis of the joints 8 provided by the bolts 8d. Each arm 4a, 4b and 5a, 5b of the scissor links 4 and 5 comprises a recess 13, which is arranged in such a way that a bolt 14 put through one of the openings 12 of the hole pattern enters the corresponding recess 13 of the respective arms 4a, 4b, 5a, 5b and hence fixes the arm 4a, 4b, 5a, 5b in its angular position corresponding to the respective opening of the hole pattern.

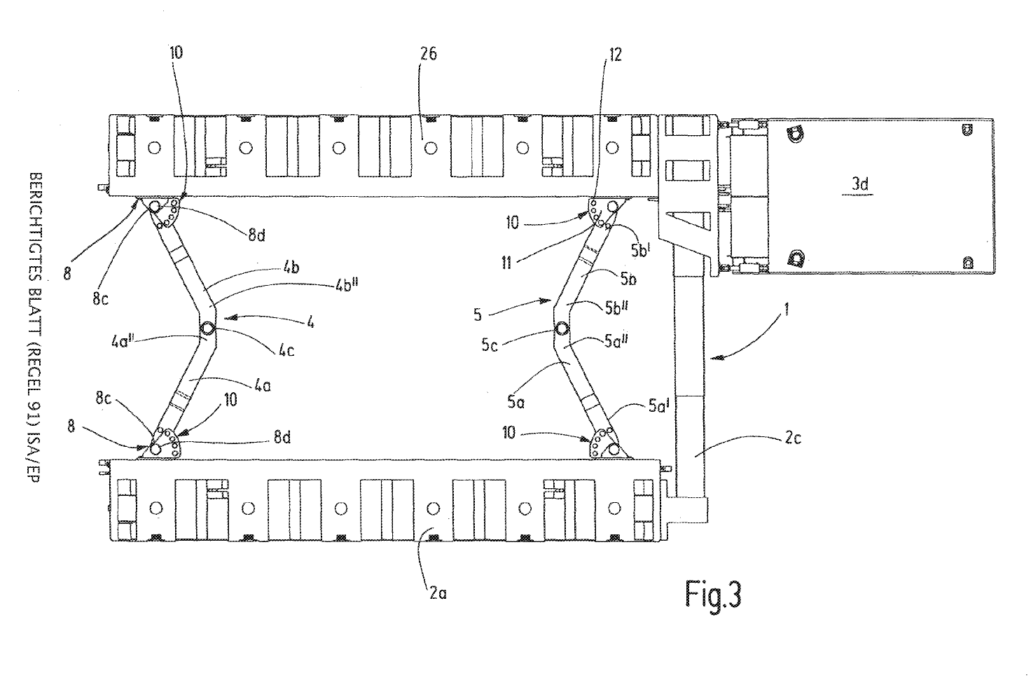

The width adjustment of the described vehicle 1 is now performed as follows: Firstly, the bolts 14 are removed, so that the arms 4a, 4b and 5a, 5b of the scissor links 4 and 5 are not fixed in their corresponding angular position any longer. If the load carriers 2a and 2b are to be moved from their broader position shown in FIG. 3 into their narrower position shown in FIG. 4, this is achieved in the described first exemplary embodiment in an advantageous way via corresponding driving movements of the transport vehicle 1. This has got the advantage that for a width adjustment of the transport vehicle 1 no further devices as e. g. hydraulic cylinders, dual wheels, by which the load carriers 2a and 2b can be moved towards each other or away from each other, are required. To move the load carriers 2a and 2b together, the steering axles of the wheel arrangements 3 of the two load carriers 2a and 2b are positioned in such a way that the dual wheels 3a—seen in the direction of the following driving movement—are turned inwardly. If the transport vehicle 1 is moved in said driving direction, this results that the dual wheels 3a move towards each other and the load carriers 2a and 2b move, due to this driving movements, inwardly. Simultaneously the length adjustable, preferably telescopable cross beam 2c slides together. After the desired width of the transport vehicle 1 has been achieved via the aforementioned driving movement, the bolts 14 are put through the respective openings 12 of the hole pattern of the perforated plate 11 and in this way the arms 4a, 4b and 5a, 5b and therefore the load carriers 2a and 2b connected with them are fixed in a defined position in respect to each other.

The moving apart of the load carriers 2a and 2b is done correspondingly: After the locking elements of the means 10, i.e. in this case the bolts 14, have been removed, the steering axles of the wheel assemblies 6 are positioned in such a way that the dual wheels 3a—seen in the aforementioned direction of travel—are arranged running spread apart. If now the transport vehicle 1 is moved in said direction, the wheels 3a move outwardly, so that the load carriers 2a and 2b are moved apart from each other. After the desired width has been reached, the bolts 14 are put into the corresponding openings 12 of the hole patterns 11. In this way a fixation of the scissor links 4 and 5 in respect to their angular position and hence to the distance between the load carriers 2a and 2b is achieved.

It is possible too, that the transport vehicle 1 comprises means known to the person skilled in the art and hence not shown, e.g. hydraulic or pneumatic cylinders, which act in traverse direction onto the load carriers 2a and 2b, in order to change the angular position of the arms 4a, 4b and 5a, 5b of the two scissor links 4 and 5 and the load carriers 2a and 2b by these means.

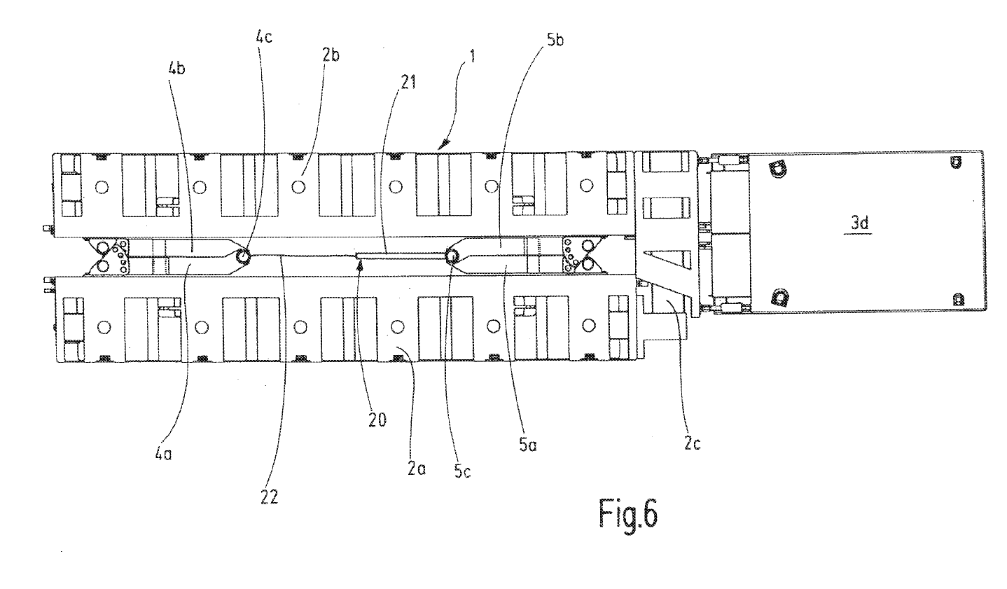

It is possible to that between the scissor links 4 and 5 a corresponding device 20 is arranged, by which the longitudinal distance between the joints 4c and 5c of the scissor links 4 and 5 can be changed, thus resulting in an adjustment of the angular positions of the arms 4a, 4b and 5a, 5b of the scissor links 4 and 5 and hence of the distance between the two load carriers 2a and 2b. In the second exemplary embodiment shown in FIGS. 5 and 6 it is provided that this device 20 for changing the longitudinal distance of the joints 4c and 5c of the scissor links 4 and 5 is a hydraulic operated double-acting cylinder 21: Through an extension of the piston rod 22 of the double-acting cylinder 21 the joints 4c and 5c are moved in the longitudinal direction of the transport vehicle 1 apart from each other, so that the load carriers 2a and 2b are moved apart from each other. In a corresponding manner the retraction of the piston rod 22 of the double-acting cylinder 21 has the effect that the distance between the joints 4c and 5c decreases, so that the load carriers 2a and 2b are moved towards each other and in this way the width of the transport vehicle 1 and hence its track width is reduced. It is of advantage if the moving together and moving apart of the load carriers 2a, 2b is supported by an appropriate positioning of the wheels 3a of the wheel assemblies 3.

In the above description it was assumed that the chassis 2 of the transport vehicle 1 only has got the two load carriers 2a and 2b connected by the scissor links 4 and 5. It is possible too to cascade the previously described arrangement, e.g. that besides the two previously described load carriers 2a and 2b connected via the scissor links 4 and 5 at least one further load carrier of the chassis 2 is provided, which is once more connected via further scissor links with the load carriers 2a and 2b respectively. It is possible to provide more than three load carriers 2a and 2b and to connect adjacent load carriers via scissor links 4 and 5.

In the above description, it was assumed that between adjacent load carriers 2a and 2b two scissor links 4 and 5 are arranged. This is not mandatory, but it is possible only to provide only one scissor link 4 or 5 between the two load carriers 2a or 2b, although this is not preferred. When using long load carriers 2a and 2b it is of advantage to provide more than two scissor links 4 and 5.

The provision of the wheel assemblies 3 of the transport vehicle 1 with corresponding steering axles is preferred, since this is a particular simple and elegant way to change the distance between the load carriers 2a and 2b and hence the width of the transport vehicle 1 via a corresponding driving movement. But this is not mandatory. It is, e.g. possible to apply a force on the scissor links 4 and/or 5 by means of a side impact of one or both load carriers 2a and/or 2b, which results in a change of the angular position of the load arms 4a, 4b and/or 5a, 5b and hence a change of the distance between the load carriers 2a and 2b. Here, the dual wheels 3a of the wheel assembly 3 are de facto pushed over the ground bearing the transport vehicle 1.

In conclusion, it must be stated that by the measures described a transport vehicle 1 is provided, which is characterized by its simple width and hence track width adjustment. By providing that at least two load carriers 2a, 2b of the chassis 2 of the transport vehicle 1 are connected via one or several scissor links 4, 5 with each other, the distance of the corresponding load carriers 2a and 2b can be increased or reduced by a simple driving movement of the transport vehicle 1 in connection with appropriately build wheel assemblies 3.

What is claimed is:

1. A transport vehicle, comprising:
a chassis comprising at least two load carriers being arranged side by side and distant from each other, whose mutual distance can be changed for varying a width of the transport vehicle;
wherein the at least two load carriers of the transport vehicle are connected by at least one scissor link;
wherein the at least one scissor link comprises a first arm and a second arm, wherein a first end portion of the first arm is pivotally connected with the first load carrier from the at least two load carriers, wherein a first end portion of the second arm is pivotally connected with the second load carrier from the at least two load carriers, wherein a second end portion of the first arm and a second end portion of the second arm are connected via a joint.

2. The transport vehicle according to claim 1, wherein the at least one scissor link connecting the at least two load carriers of the transport vehicle now comprises at least two scissor links connecting the at least two load carriers of the transport vehicle.

3. The transport vehicle according to claim 1, wherein the at least two load carriers are connected via at least one length-adjustable cross beam.

4. The transport vehicle according to claim 2, wherein each scissor link has at least one means for defining an angular position of the first or second arm relative to its respective load carrier.

5. The transport vehicle according to claim 4, wherein the at least one means for defining an angular position of the first or second arm relative to its respective load carrier comprises a perforated plate attached to its respective load carrier, where the perforated plate has several openings defining a hole pattern through which a locking element is configured to be lead through securing the first or second arm relative to its respective load carrier.

6. The transport vehicle according to claim 1, wherein the chassis of the transport vehicle comprises a plurality of wheel assemblies.

7. The transport vehicle according to claim 6, wherein at least one wheel assembly of the plurality of wheel assemblies is steerable.

8. The transport vehicle according to claim 2, wherein the transport vehicle comprises a device configured to change the angular position of the at least two scissor links relative to the first and second load carriers.

9. The transport vehicle according to claim 8, wherein said device is connected to and engages with the at least two scissor links.

10. The transport vehicle according to claim 9, wherein the device is a double-acting cylinder.
